(19) United States
(12) Patent Application Publication
(10) Pub. No.: US 2005/0011556 A1
(43) Pub. Date: Jan. 20, 2005

(54) Spool position detection for a hydraulic valve

(76) Inventors: Mariusz Dudzik, Castle Hill (AU); Paul Donnelly, Castle Hill (AU); Ric Tamba, Castle Hill (AU)

Correspondence Address: MCDERMOTT WILL & EMERY LLP, 600 13th Street, N.W., Washington, DC, 20005-3096, US

(21) Appl. No.: 10/869,041

(22) Filed: Jun. 17, 2004

Related U.S. Application Data
(60) Provisional application No. 60/517,081, filed on Nov. 5, 2003.

(30) Foreign Application Priority Data
Jun. 17, 2003 (AU) 2003903036

(51) Int. Cl. F16K 37/00

(52) U.S. Cl. 137/554

(57) ABSTRACT

A position sensor senses the position of an article that moves over a short predetermined path. The position sensor is contained in a housing which is mounted in a fixed location adjacent the article and has an internal cavity in which a valve follower travels guided by the walls of the cavity to describe a predetermined path in the axial direction. The valve follower is operatively coupled with the article and carries a sensed magnetic element. A sensor is mounted in the housing adjacent the path of the valve follower, such that the sensed element moves laterally under the sensor and the sensor generates a signal indicative of its position.

### INTRODUCTION

The present invention relates generally to the field of hydraulic controls and in particular, the invention provides an improved hydraulic valve position-monitoring sensor which improves the reliability of valve monitoring.

### BACKGROUND TO THE INVENTION

Hydraulic valves are used in machinery to control motive force by controlling the flow of hydraulic fluid into rams, pistons, valves and hydraulic motors used for both motion of the machine itself, and/or motion of implements or other moving components of the machine such as press components, digging implements, etc.

Generally, hydraulic machinery is provided with safety systems to prevent undesired movement of the machine or machine components at various points in the operation of the machine. For example, it is common to provide a safety screen on a hydraulic press to prevent access while the press is operating and to have interlocks on the screen, which prevent operation whenever the safety screen is not in its closed position. It is also common to put pressure sensors on the downstream side of a hydraulic valve to detect pressure in the hydraulic circuit of a machine and to prevent certain activities from occurring if the hydraulic circuit is pressurised. However, when the machine is initially started, the pressure sensor will read 0 (zero) pressure because the hydraulic pump is not operating and therefore there is no pressure on either side of the hydraulic valve. The pressure sensor will not read a pressure sufficient to indicate a dangerous situation, until such time as the hydraulic fluid has passed through the valve to create pressure in the downstream side of the circuit. During the instant while the pressure is building up to the level where the pressure sensor will trip, and due to delays and inertia after the sensor has detected a pressure, there will also be motion of the equipment driven by that hydraulic circuit and this can, in some circumstances, be quite dangerous and result in the accidental injury of a worker who might not have expected the equipment to move when the hydraulic pump was started. Every year there are a significant number of deaths in industry caused by unintentional movement of a machine at start-up and the device of the present invention in intended to reduce the possibility of occurrence of such accidents.

It is also known to provide position monitors on valve spools to detect when a valve is open, however, such monitors detect only an open or closed condition and not the extent of opening of the valve and, in some circumstances fail to detect opening of the valve where the opening is slight. In particular, the accuracy of such prior art monitors depends on physical tolerances of the valve, the sensor and the fitment of the sensor to the valve and the operating temperature. Therefore, such arrangements are prone to false sensing of (for example) a closed position when the sensor is incorrectly adjusted or tolerances are exceeded.

### SUMMARY OF THE INVENTION

According to a first aspect, the present invention provides a valve spool monitor comprising position sensing means arranged to be mounted adjacent to a valve spool of a hydraulic valve and arranged to measure the absolute position of the spool within the valve and to provide an output signal indicative of the absolute position.

According to a second aspect, the present invention provides a method of monitoring a valve spool, the method comprising locating a position sensing means adjacent to a valve spool of a hydraulic valve, to measure the absolute position of the spool within the valve and to provide an output signal indicative of the absolute position.

In a preferred embodiment, the position sensing means comprises a first, sensed, component mounted in the valve spool or on a member operatively coupled with and moving in unison with the valve spool, and a second, sensor, element located adjacent a path described by the sensed component when the valve spool travels through its stroke, such that the sensed component passes under the sensor element as it travels along its path.

According to a third aspect, the present invention provides a position sensor for sensing the position of an article that moves over a short predetermined path, the position sensor comprising a housing, mounting means arranged to permit mounting of the housing in a fixed location adjacent the article, the housing having an internal cavity having a substantially constant cross section along an axial direction of the cavity and in which is located a travelling element configured to cooperate with the walls of the cavity to be guided to describe a predetermined path in the axial direction, coupling means arranged to operatively couple the travelling element with the article, a sensed element being mounted on the travelling element and a sensor being mounted in or on the housing adjacent the path of the travelling element, such that the sensed element moves laterally under the sensor and whereby the sensor senses the position of the sensed element and generates a signal indicative of its position.

According to a fourth aspect, the present invention provides a method of sensing the position of an article that moves over a short predetermined path comprising mounting a housing enclosing a monitor assembly in a fixed location adjacent the article, providing the housing with an internal cavity and internal guiding surfaces extending in an axial direction of the cavity, locating a travelling member between the guiding surfaces to be guided to describe a predetermined path in the axial direction, operatively coupling the travelling member with the article, locating a sensed element relative to the travelling member and locating a sensor adjacent the path of the travelling member, such that the sensed element moves laterally under the sensor and whereby the sensor senses the position of the sensed element and generates a signal indicative of its position, to indicate the position of the article.

Preferably, the sensed component is a magnet mounted on a member extending in the axis of the valve spool and coupled to the valve spool to move therewith, and the sensor is preferably a magnetic field angle sensor located adjacent to a path described by the magnet, whereby the magnetic field angle sensor determines valve position by monitoring the change in angle of the magnetic field of the magnet at the sensor as the magnet moves past the sensor.

Preferably also, the valve spool monitor or position sensor further includes processing means to convert the sensor output signal to an assembly output signal whereby the sensor output signal is indicative of the instantaneous position of the valve and the assembly output signal, includes discrete levels which indicate closed and opened position signals.

### BRIEF DESCRIPTION OF THE DRAWINGS

An embodiment of the invention will now be described by way of example with reference to the accompanying drawings, in which:

FIG. 1 shows a partial cutaway side view of a hydraulic valve with a first embodiment of a sensor assembly added according to an embodiment of the present invention;

FIG. 2 is an end view of the sensor assembly of FIG. 1, showing the interface with the hydraulic valve;

FIG. 3 is a schematic illustration of the electronic and magnetic function of the sensor assembly of FIG. 1; and

FIG. 4 shows a partial cutaway side view of a hydraulic valve with a second embodiment of a sensor assembly added.

### DETAILED DESCRIPTION OF THE PREFERRED EMBODIMENT

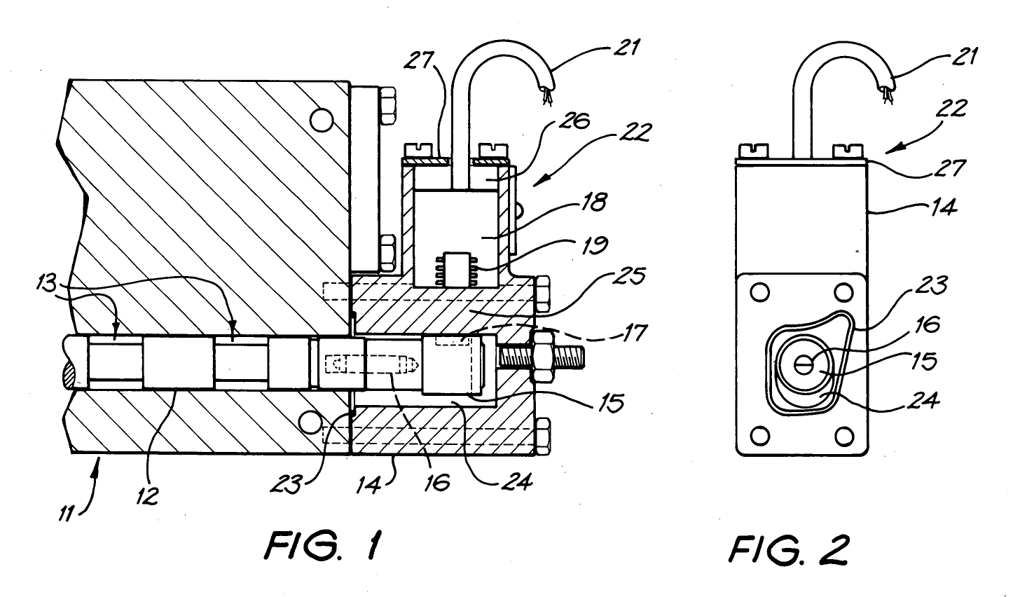

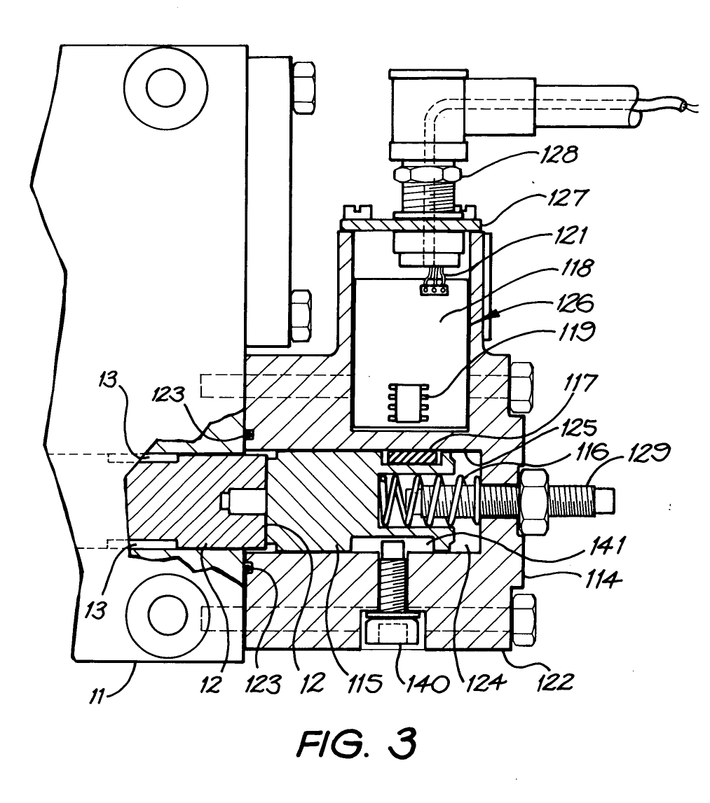

A first embodiment of a valve sensor is illustrated in FIGS. 1 and 2, which show a partial cutaway side view and an end view respectively, of a hydraulic valve with a valve sensor assembly attached. In FIG. 1, a valve body 11, housing a valve spool 12, having valve porting 13 is provided with a sensor assembly 22, attached to the rear of the valve housing. The sensor assembly 22 comprises a sensor housing 14 in which is housed a valve spool extension member 15 operatively coupled with the valve spool 12 to act as a valve spool follower and, in this case, physically connected to the valve spool 12 by a linkage 16. The valve spool extension member 15 travels in a cavity 24 in the sensor housing 14, and has mounted on one side, a magnet element 17 which is located adjacent to one side of the cavity 24. The magnetic element 17 travels backwards and forwards along a surface of a wall 25 of the sensor housing 14 when the valve spool 12 moves in the hydraulic valve body 11 such that the magnetic element 17 moves under a sensor element 19, housed in a second chamber 26 of the sensor assembly 22. The sensor element 19 is mounted to a sensor electronics board 18, also mounted within the chamber 26 and a signal cable 21 extends from the electronics board 18 through an aperture in an end cap 27 of the chamber 26 and then runs to a control system of the machine to which the hydraulic valve is connected.

Because the sensor relies on field direction, it is independent of magnet strength and temperature and therefore its accuracy is relatively independent of operating conditions.

A seal 23 is provided between the valve body 11 and the sensor housing 14 and extends around the spool 12 to prevent loss of hydraulic fluid from the valve into the chamber 24 of the sensor body 14.

Referring to FIG. 3, a second embodiment of a valve sensor is illustrated in which a partial cutaway side view of a hydraulic valve with a sensor attached is again shown. The valve body 11 in FIG. 3 is similar to that shown in FIGS. 1 & 2 and houses a valve spool 12, having valve porting 13. The FIG. 3 valve body 11 is provided with a sensor assembly 122, attached to the rear of the valve housing. The sensor assembly 122 which comprises a sensor housing 114 in which is housed a valve spool extension member 115 operatively coupled with the valve spool 112 to act as a valve spool follower and is biased into engagement with the valve spool 12 by a spring 116. A guide 129 is screwed through the housing 114 and extends down the centre of the spring 116 to maintain the spring in alignment and to act as a stop for the valve spool extension member 115 to prevent over-compression of the spring 116 and to calibrate the position of the valve spool, 12. The valve spool extension member 115 travels in a cavity 124 in the sensor housing 114, and is retained by a screw 140 extending through the side of the housing 114 and into a slot 141 in the side of the valve spool extension member, which prevents rotation of the valve spool extension member.

The valve spool extension member 115 has mounted on one side, a magnet element 117 which is located adjacent to one side of the cavity 124. The magnetic element 117 travels backwards and forwards along a surface of a wall 125 of the sensor housing 114 when the valve spool 12 moves in the hydraulic valve body 11 such that the magnetic element 117 moves under a sensor element 119, housed in a second chamber 126 of the sensor assembly 122. The sensor element 119 is mounted to a sensor electronics board 118, also mounted within the chamber 126 and a signal cable 121 extends from the electronics board 118 through a conduit 128 extending through an end plate 127 of the chamber 126 and then runs to a control system of the machine to which the hydraulic valve is connected.

A seal 123 is provided between the valve body 11 and the sensor housing 114 as in the first embodiment and extends around the spool 12 to prevent loss of hydraulic fluid from the valve to atmosphere.

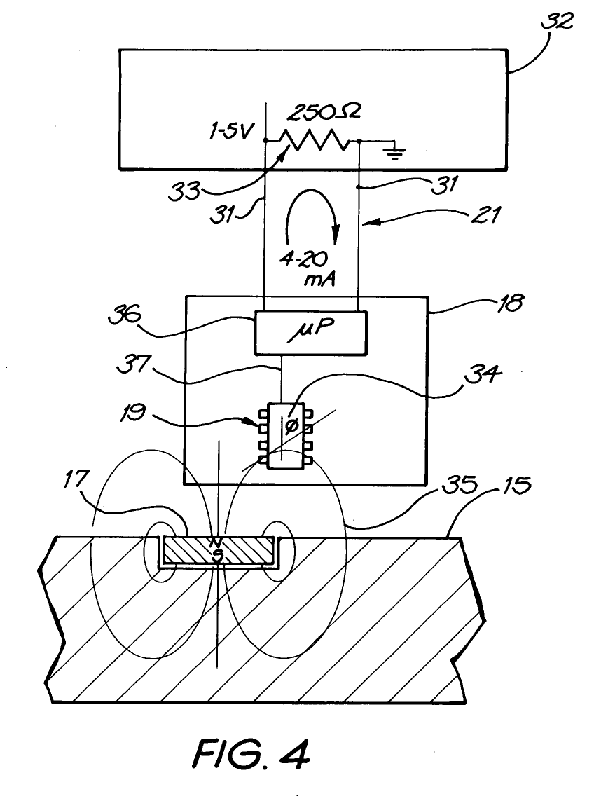

Referring to FIG. 4, the electronic and magnetic function of the sensor assembly 22, 122 are schematically illustrated. For convenience, the description of the circuit of FIG. 4 will refer to the elements described in relation to the embodiment of FIGS. 1 & 2 however this circuit will operate identically with the embodiment of FIG. 3. It will be seen in FIG. 4 that the magnet 15 produces lines of magnetic field radiating out of the upper (eg; north) pole of the magnet and these lines pass through the sensor chip 19 mounted on the electronics board 18 of the sensor assembly.

In the preferred embodiment, the chip is a Honeywell™ Linear/Angular/Rotary Displacement Sensor, model HMC1501 or HMC1512. Each of these devices operate on the effect of anisotropic magnetoresistance (AMR) which occurs in ferrous materials. AMR is a change in resistance which occurs when a magnetic field is applied in a thin strip of ferrous material such as a permalloy thin film (NiFe). The magnetoresistance is a function of Cos² where is the angle between magnetization M and current flow in the thin strip. When the magnetic field applied to the Honeywell™ HMC1501 or HMC1512 devices is greater than 80 Oe, the magnetization aligns in the direction of the applied field; this is called saturation mode. In this mode, is the angle between the applied field and the current flow.

In the present application, the sensor chip 19 measures a field angle being the angle 34 between the axis of the chip and a field direction of field lines 35 passing through the chip. The circuit board 18 carries a circuit which interfaces the sensor chip output 37 of a signal representing the field angle to a microprocessor which converts the field angle signal into a digital position signal representing the linear position of the magnetic element 17 and hence the valve spool 12. The microprocessor 36 then further processes the position signal to provide a value status output. In the preferred embodiment, the microprocessor is a Microchip™, PIC12CE674™. This 8 pin DIL packaged integrated circuit has analogue inputs, digital input/output and EEPROM data storage in which the calibration data is held. The microprocessor 36 outputs valve status information which is converted to a 4-20 mA signal 21 carried on a current loop circuit 31 to the control system 32 of the machine to which the valve is fitted. In the control system 32, the 4-20 mA signal is typically passed through a 250 Ω resistor to convert it to a 1-5 volt signal.

The 4-20 mA signal uses the following protocol to indicate value status:
i)<4 mA—Fault condition
ii) 5 mA—Out of calibration
iii) 8 mA—valve open to right side
iv) 12 mA—valve closed
v) 16 mA—valve open to left side.

After installation of a sensor unit, the sensor unit is calibrated. The valve is moved towards hydraulic crack point and then moved back till there is no flow. The equivalent absolute location is then read from the sensor and programmed into EEPROM of the microprocessor. Calibration is performed separately for the right and left crack point positions of the valve.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A valve spool monitor comprising position sensing means arranged to be mounted adjacent to a valve spool of a hydraulic valve, to measure the absolute position of the spool within the valve and to provide an output signal indicative of the absolute position.

2. The valve spool monitor as claimed in claim 1, wherein the position sensing means comprises a sensed component mounted relative to the valve spool and a sensor element located adjacent a path described by the sensed component when the valve spool travels through its stroke, such that the sensed component passes under the sensor element as it travels along its path and the sensor provides an output indicative of the position of the valve spool.

3. The valve spool monitor as claimed in claim 1, wherein the position sensing means comprises a valve spool following member operatively coupled with and moving in unison with the valve spool, a sensed component mounted relative to the valve spool following member and a sensor element located adjacent a path described by the sensed component when the valve spool travels through its stroke, such that the sensed component passes under the sensor element as it travels along its path and the sensor provides an output indicative of the position of the valve spool.

4. The valve spool monitor as claimed in claim 1, the valve spool monitor comprising a housing, mounting means arranged to permit mounting of the housing in a fixed location adjacent the article, the housing having an internal cavity and internal guiding surfaces extending in an axial direction of the cavity and between which is located a valve spool following member configured to cooperate with the guiding surfaces to be guided to describe a predetermined path in the axial direction, coupling means arranged to operatively couple the valve spool following member with the article, a sensed element being mounted relative to the valve spool following member and a sensor being mounted adjacent the path of the valve spool following member, such that the sensed element moves laterally under the sensor and whereby the sensor senses the position of the sensed element and generates a signal indicative of its position, to indicate the position of the article.

5. The method of claim 4, wherein the cavity has substantially constant cross section in the axial direction such that its walls provide the guiding surfaces and the valve spool following member is configured to cooperate with the walls of the cavity to be guided to describe a predetermined path in the axial direction.

6. The valve spool monitor as claimed in claim 4, wherein the sensed component is a magnet mounted relative to the valve spool following member and operatively coupled with the valve spool to move therewith, and the sensor is a magnetic field angle sensor located adjacent to a path described by the magnet, whereby the magnetic field angle sensor determines the position of the article by monitoring the change in angle of the magnetic field of the magnet at the sensor as the magnet moves past the sensor.

7. The valve spool monitor as claimed in claim 6, wherein the monitor further includes processing means to convert the signal generated by the sensor to an assembly output signal whereby the signal generated by the sensor is indicative of the instantaneous position of the valve and the assembly output signal includes discrete levels which indicate valve open and valve closed positions of the valve spool.

8. The valve spool monitor as claimed in claim 7, wherein the valve spool following member is operatively coupled to the valve spool by a spring urging the valve spool following member against an end of the valve spool whereby the valve spool following member follows the valve spool as it moves in the axial direction.

9. The valve spool monitor as claimed in claim 7, wherein the valve spool following member is operatively coupled to the valve spool by a linkage connecting the valve spool following member to the valve spool whereby the valve spool following member follows the valve spool as it moves in the axial direction.

10. A position sensor for sensing the position of an article that moves over a short predetermined path, the position sensor comprising a housing, mounting means arranged to permit mounting of the housing in a fixed location adjacent the article, the housing having an internal cavity and internal guiding surfaces extending in an axial direction of the cavity and between which is located a travelling member configured to co-operate with the guiding surfaces to be guided to describe a predetermined path in the axial direction, coupling means arranged to operatively couple the travelling member with the article, a sensed element being mounted relative to the travelling member and a sensor being mounted adjacent the path of the travelling member, such that the sensed element moves laterally under the sensor and whereby the sensor senses the position of the sensed element and generates a signal indicative of its position, to indicate the position of the article.

11. The position sensor as claimed in claim 15, wherein the cavity has substantially constant cross section in the axial direction such that its walls provide the guiding surfaces and the travelling member is configured to cooperate with the walls of the cavity to be guided to describe a predetermined path in the axial direction.

12. The position sensor as claimed in claim 10, wherein the sensed component is a magnet mounted relative to the travelling member and operatively coupled with the article to move therewith, and the sensor is a magnetic field angle sensor located adjacent to a path described by the magnet, whereby the magnetic field angle sensor determines the position of the article by monitoring the change in angle of the magnetic field of the magnet at the sensor as the magnet moves past the sensor.

13. The position sensor as claimed in claim 10, wherein the position sensor further includes processing means to convert the signal generated by the sensor to an assembly output signal whereby the signal generated by the sensor is indicative of the instantaneous position of the valve and the assembly output signal includes discrete levels which indicate specific positions of the article.

14. The position sensor as claimed in claim 10, wherein the article is a valve spool and the assembly output signal includes discrete levels which indicate valve open and valve closed positions of the valve spool.

15. The position sensor as claimed in claim 14, wherein the travelling member is operatively coupled to the valve spool by a spring urging the valve spool following member against an end of the valve spool whereby the valve spool following member follows the valve spool as it moves in the axial direction.

16. The position sensor as claimed in claim 14, wherein the travelling member is operatively coupled to the valve spool by a linkage connecting the travelling member to the valve spool whereby the travelling member follows the valve spool as it moves in the axial direction.

17. A method of monitoring a valve spool, the method comprising locating a position sensing means adjacent to a valve spool of a hydraulic valve, to measure the absolute position of the spool within the valve and to provide an output signal indicative of the absolute position.

18. The method of monitoring a valve spool as claimed in claim 17, wherein locating the position sensing means comprises locating a sensed component relative to the valve spool and locating a sensor element adjacent a path described by the sensed component when the valve spool travels through its stroke, such that the sensed component passes under the sensor element as it travels along its path and the sensor provides an output indicative of the position of the valve spool.

19. The valve spool monitor as claimed in claim 17, wherein locating the position sensing means comprises operatively coupling a valve spool following member with the valve spool to move in unison with the valve spool, locating a sensed component relative to the valve spool following member and locating a sensor element adjacent a path described by the sensed component when the valve spool travels through its stroke, such that the sensed component passes under the sensor element as it travels along its path and the sensor provides an output indicative of the position of the valve spool.

20. The method of monitoring a valve spool as claimed in claim 17, further comprising mounting a housing enclosing a monitor assembly in a fixed location adjacent the valve spool, providing the housing with an internal cavity and internal guiding surfaces extending in an axial direction of the cavity, locating a valve spool following member between the guiding surfaces to be guided to describe a predetermined path in the axial direction, operatively coupling the valve spool following member with the valve spool, locating a sensed element relative to the valve spool following member and locating a sensor adjacent the path of the valve spool following member, such that the sensed element moves laterally under the sensor and whereby the sensor senses the position of the sensed element and generates a signal indicative of its position, to indicate the position of the valve spool.

21. The method of claim 20, wherein the cavity is provided with substantially constant cross section along an axial direction such that its walls provide the guiding surfaces and the travelling member is configured to cooperate with the walls of the cavity to be guided to describe a predetermined path in the axial direction.

22. The method of monitoring a valve spool as claimed in claim 20, wherein the sensed component is a magnet and the sensor is a magnetic field angle sensor and the method includes locating the magnet on a valve spool following member and operatively coupled with the valve spool to move therewith, and locating the magnetic field angle sensor adjacent to a path described by the magnet, whereby the position of the article is determined by monitoring a change in angle of the magnetic field of the magnet at the sensor as the magnet moves past the sensor.

23. The method of monitoring a valve spool as claimed in claim 22, wherein the position sensor further includes processing means to convert the signal generated by the sensor to an assembly output signal and the method further includes processing the signal generated by the sensor, indicative of the instantaneous position of the valve to produce an assembly output signal comprising discrete levels which indicate valve open and valve closed positions of the valve spool.

24. The method of monitoring a valve spool as claimed in claim 23, wherein the method further comprises operatively coupling the valve spool following member to the valve spool by a spring to urge the valve spool following member against an end of the valve spool whereby the valve spool following member follows the valve spool as it moves in the axial direction.

25. The method of monitoring a valve spool as claimed in claim 23, wherein the method further comprises operatively coupling the valve spool following member to the valve spool by a linkage to connect the valve spool following member to the valve spool whereby the valve spool following member follows the valve spool as it moves in the axial direction.

26. A method of sensing the position of an article that moves over a short predetermined path comprising mounting a housing enclosing a monitor assembly in a fixed location adjacent the article, providing the housing with an internal cavity and internal guiding surfaces extending in an axial direction of the cavity, locating a travelling member between the guiding surfaces to be guided to describe a predetermined path in the axial direction, operatively coupling the travelling member with the article, locating a sensed element relative to the travelling member and locating a sensor adjacent the path of the travelling member, such that the sensed element moves laterally under the sensor and whereby the sensor senses the position of the sensed element and generates a signal indicative of its position, to indicate the position of the article.

27. The method of claim 26, wherein the cavity is provided with a substantially constant cross section along an axial direction such that its walls provide the guiding surfaces and the travelling member is configured to cooperate with the walls of the cavity to be guided to describe a predetermined path in the axial direction.

28. The method as claimed in claim 26, wherein the sensed component is a magnet and the sensor is a magnetic field angle sensor and the method further comprises locating the magnet relative to the travelling member and operatively coupled with the article to move therewith, and locating the magnetic field angle sensor adjacent to a path described by the magnet, whereby the magnetic field angle sensor determines the position of the article by monitoring the change in angle of the magnetic field of the magnet at the sensor as the magnet moves past the sensor.

29. The method as claimed in claim 26, wherein the position sensor further includes processing means to convert the signal generated by the sensor to an assembly output signal and the method further includes processing the signal generated by the sensor, indicative of the instantaneous position of the valve to produce the assembly output signal comprising discrete levels which indicate specific positions of the article.

30. The method as claimed in claim 29, wherein the article is a valve spool and the assembly output signal includes discrete levels which indicate valve open and valve closed positions of the valve spool.

31. The method as claimed in claim 30, wherein the method further comprises operatively coupling the travelling member to the valve spool by a spring to urge the travelling member against an end of the valve spool whereby the travelling member follows the valve spool as it moves in the axial direction.

32. The method as claimed in claim 30, wherein the method further comprises operatively coupling the travelling member to the valve spool by a linkage to connect the travelling member to the valve spool whereby the travelling member follows the valve spool as it moves in the axial direction.
